(19) United States
(12) Patent Application Publication
(10) Pub. No.: US 2012/0067563 A1
(43) Pub. Date: Mar. 22, 2012

(54) CASING FRIENDLY, SHEARABLE HARDBANDS AND SYSTEMS AND METHODS FOR SHEARING SAME

(75) Inventor: Michael Joseph Jellison, Houston, TX (US)

(73) Assignee: National Oilwell Varco, L.P., Houston, TX (US)

(21) Appl. No.: 13/232,438

(22) Filed: Sep. 14, 2011

Related U.S. Application Data
(60) Provisional application No. 61/384,026, filed on Sep. 17, 2010.

(51) Int. Cl. E21B 33/06; F16D 9/06; B05D 1/36

(52) U.S. Cl. 166/85.4; 427/202; 427/205; 403/2

(57) ABSTRACT

A tool joint comprises a body having a central axis, a first end, and a second end opposite the first end, wherein the body is made of a first material having a first hardness. In addition, the tool joint comprises an annular hardband disposed about the body. The hardband is made of a second material. The second material comprises a base material and a plurality of discrete pellets dispersed throughout the base material. The base material has a second hardness and the pellets have a third hardness. The second hardness is substantially the same as the first hardness. The third hardness is greater than the second hardness and less than the hardness of tungsten carbide.

### CROSS-REFERENCE TO RELATED APPLICATIONS

This application claims benefit of U.S. provisional patent application Ser. No. 61/384,026 filed Sep. 17, 2010, and entitled “Casing Friendly, Shearable Hardbands and Systems and Methods for Shearing Same,” which is hereby incorporated herein by reference in its entirety.

### STATEMENT REGARDING FEDERALLY SPONSORED RESEARCH OR DEVELOPMENT

Not applicable.

### BACKGROUND

1. Field of the Invention

The invention relates generally to apparatus, systems, and methods for severing a downhole equipment. More particularly, the invention relates to hardfacing for downhole equipment (e.g., tubulars, tools, joints, etc.) that is both casing friendly and shearable by the shear rams of a blowout preventer.

2. Background of the Technology

Oilfield operations are typically performed to locate, access, and recover valuable downhole fluids. Oil rigs are positioned at wellsites, and downhole tools, such as drilling tools, are deployed to access subsurface reservoirs. Once the downhole tools form a subterranean wellbore, casings may be cemented into place within the wellbore, and the wellbore completed to initiate production of fluids from the reservoir. During downhole operations (e.g., drilling, completion, and production) various tubulars (e.g., pipes, drillpipe, coiled tubing, production tubing), downhole tools (e.g., drill bits, logging tools, etc.), and associated hardware (e.g., wireline, slickline, drill collars, tool joints, etc.) are passed through the wellbore casing. Such devices may move axially, radially, and rotationally relative to the casing through which they extend. As the downhole equipment moves within the casing, it may periodically contact and slide or rub against the casing.

Hardfacing is often applied to the outer surface of downhole tools such as tubulars, drilling tools, and tool joints to protect the downhole tools. Typically, hardfacing is applied to the outer surface by welding the hardfacing material thereon. The process of applying hardfacing to downhole tools is often referred to as “hardbanding,” and the hardfacing applied is often referred to as a “hardband.” However, wear to the casing due to rubbing and sliding of the hardband against the inner surface of the casing during downhole operations may undesirably create thin spots along the casing, which weaken the casing and compromise the well's integrity.

Leakage of subsurface fluids may pose a significant environmental threat if released from the wellbore. Thus, equipment, such as blowout preventers (BOPs), are often positioned about the wellbore to form a seal about downhole equipment extending therethrough to prevent leakage of fluid as it is brought to the surface. Typical blowout preventers have selectively actuatable rams or ram bonnets, such as pipe rams or shear rams, that may be activated to seal the wellbore. In general, pipe rams engage and seal against the equipment extending through the BOP, whereas shear rams physically shear the equipment extending through the BOP. Thus, for example, if a hardband on a tubular or joint is positioned between the shear rams of a BOP, the hardband must be capable of being sheared in order for the BOP shear rams to serve their function of containing the well during a blowout situation. If the BOP shear rams cannot shear the hardband, the BOP may not be able to contain the well, potentially resulting in an environmental disaster and/or injury to rig personnel. Despite the development of techniques for cutting tubulars with BOP shear rams, some conventional shear rams have struggled to reliably sever certain types of downhole tools, particularly when the tools includes hardfacing or hardbanding.

Most conventional hardbands are either shearable or casing friendly, but not both. For example, one conventional type of hardband comprises tungsten carbide (WC) particles dispersed in a mild steel matrix. The tungsten carbide particles enhance the overall hardness of the hardband, thereby providing protection to the underlying tool or joint. The discrete, dispersed tungsten carbide particles are urged out of the way by the cutting edge of BOP shear rams as they engage and begin to penetrate the softer, mild steel matrix. Thus, such hardbands are generally shearable (i.e., capable of being cut with BOP shear rams). However, the extremely hard and abrasive tungsten carbide particles often cause severe and unacceptable casing wear, and thus, are not considered “casing friendly.” In particular, over time, rubbing of the hardband material against the casing wears away the softer, mild steel matrix material faster than the tungsten carbide particles. As the mild steel matrix wears away, the plurality of dispersed, discrete tungsten carbide particles left behind at the surface of the hardband tend to create a rough surface texture that operates like a grinding wheel on the inner surface of the casing.

Another conventional type of hardband comprises a single-phase, continuous metal alloy such as chromium carbide, iron carbide, or titanium carbide. The consistent, single phase material does not contain discrete particles, and thus, tends to wear more evenly and smoothly compared to hardband comprising tungsten carbide particles dispersed in a mild steel matrix. Further, these single phase materials have a lower hardness and are less abrasive than tungsten carbide. As a result, this type of single-phase hardband is generally casing friendly. However, to provide protection to the tool or joint, the single-phase material is typically harder than the base metal of the tool or joint to which it is applied. Due to the enhanced hardness and single-phase composition, such conventional hardbands are typically not shearable (i.e., are not capable of being cut with BOP shear rams). Moreover, since this type of hardband comprises a single-phase material that is metallurgically different, and thus, has a different coefficient of thermal expansion, than the underlying base metal of the tool or joint to which it is applied, the hardband material may be susceptible to cracking and spalling over extended use in the harsh downhole environment.

Accordingly, there remains a need in the art for improved hardband materials for downhole equipment such as tubulars, tools, and tool joints. Such hardband materials would be particularly well received if they were both shearable and casing friendly. Moreover, there remains a need in the art for improved BOP shear rams capable of reliably shearing downhole equipment. Such shear rams would be particularly well-received if they were capable of reliably shearing downhole equipment that included hardfacing and hardbanding.

### BRIEF SUMMARY OF THE DISCLOSURE

These and other needs in the art are addressed in one embodiment by a tool joint. In an embodiment, the tool joint comprises a body having a central axis, a first end, and a second end opposite the first end, wherein the body is made of a first material having a first hardness. In addition, the tool joint comprises an annular hardband disposed about the body. The hardband is made of a second material. The second material comprises a base material and a plurality of discrete pellets dispersed throughout the base material. The base material has a second hardness and the pellets have a third hardness. The second hardness is substantially the same as the first hardness. The third hardness is greater than the second hardness and less than the hardness of tungsten carbide.

These and other needs in the art are addressed in another embodiment by a system. In an embodiment, the system comprises a blowout preventer including a body, a throughbore in fluid communication with a wellbore, a shear ram, and an actuator configured to move the shear ram from a first positioned retracted from the throughbore and a second position extending across the throughbore. In addition, the system comprises a tool joint disposed in the throughbore of the blowout preventer radially adjacent the shear ram. The tool joint comprises a body and an annular hardband disposed about the body. The body is made from a first material and the hardband is made from a second material. The second material includes a base material and a plurality of discrete pellets dispersed throughout the base material. The base material has substantially the same hardness as the first material, and the pellets have a hardness greater than 35 HRC and less than 2300 HV.

These and other needs in the art are addressed in another embodiment by a method for forming a hardband on a downhole tool, the downhole tool being made of a first material. In an embodiment, the method comprises (a) applying a molten base material onto the downhole tool. The base material has a coefficient of thermal expansion that is within 10% of the coefficient of thermal expansion of the first material. In addition, the method comprises (b) dispersing a plurality of solid pellets throughout the molten base material. The pellets have a hardness that is greater than a hardness of the base material and less than 2300 HV. Further, the method comprises (c) allowing the molten base material to cool and transition into a solid.

Embodiments described herein comprise a combination of features and advantages intended to address various shortcomings associated with certain prior devices, systems, and methods. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the preferred embodiments of the invention, reference will now be made to the accompanying drawings in which:

FIG. 1 is a schematic view of an embodiment of an offshore wellsite including a blowout preventer;

FIG. 2A is a schematic, partial cross-sectional side view of the shear ram BOP of FIG. 1 prior to initiating a severing operation;

FIG. 2B is a schematic, partial cross-sectional top view of the shear ram BOP of FIG. 2A prior to initiating a severing operation;

FIG. 2C is a schematic, partial cross-sectional side view of the shear ram BOP of FIG. 2A during a severing operation;

FIG. 3A is a top perspective view of an embodiment of shear ram for a blowout preventer;

FIG. 3B is a bottom perspective view of the shear ram of FIG. 3A;

FIG. 3C is a top view of the shear ram of FIG. 3A;

FIG. 3D is a side view of the shear ram of FIG. 3A;

FIG. 4A is a top perspective view of an embodiment of shear ram for a blowout preventer;

FIG. 4B is a bottom perspective view of the shear ram of FIG. 4A;

FIG. 4C is a top view of the shear ram of FIG. 4A;

FIG. 4D is a cross-section view along line 4D-4D of FIG. 4A;

FIG. 5A is a top perspective view of an embodiment of shear ram for a blowout preventer;

FIG. 5B is a bottom perspective view of the shear ram of FIG. 5;

FIG. 5C is a top view of the shear ram of FIG. 5A;

FIG. 5D is a cross-section view along line 5D-5D of FIG. 5A;

FIG. 6A is a top perspective view of an embodiment of shear ram for a blowout preventer;

FIG. 6B is a bottom perspective view of the shear ram of FIG. 6A;

FIG. 6C is a top view of the shear ram of FIG. 6A;

FIG. 6D is a cross-section view along line 6D-6D of FIG. 6A;

FIG. 7A is a top perspective view of an embodiment of shear ram for a blowout preventer;

FIG. 7B is a bottom perspective view of the shear ram of FIG. 7A;

FIG. 7C is a top view of the shear ram of FIG. 7A;

FIG. 7D is a cross-section view along line 7D-7D of FIG. 7A;

FIG. 8A is a top perspective view of an embodiment of shear ram for a blowout preventer;

FIG. 8B is a bottom perspective view of the shear ram of FIG. 8A;

FIG. 8C is a top view of the shear ram of FIG. 8A;

FIG. 8D is a cross-section view along line 8D-8D of FIG. 8A;

FIG. 9A is a top perspective view of an embodiment of shear ram for a blowout preventer;

FIG. 9B is a bottom perspective view of the shear ram of FIG. 9A;

FIG. 9C is a top view of the shear ram of FIG. 9A;

FIG. 9D is a cross-section view along line 9D-9D of FIG. 9A;

FIG. 10A is a top perspective view of an embodiment of shear ram for a blowout preventer;

FIG. 10B is a bottom perspective view of the shear ram of FIG. 10A;

FIG. 10C is a top view of the shear ram of FIG. 10A;

FIG. 10D is a cross-section view along line 10D-10D of FIG. 10A;

FIG. 11 is a perspective view of an embodiment of a downhole tool including a casing friendly, shearable hardband in accordance with the principles described herein;

FIG. 12 is a perspective view of the tool of FIG. 11;

FIG. 13 is a schematic, partial cross-sectional view of the tool of FIG. 11; and

FIG. 14 is an enlarged, schematic partial cross-sectional view of the hardband of FIGS. 11 and 12.

### DETAILED DESCRIPTION OF SOME OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

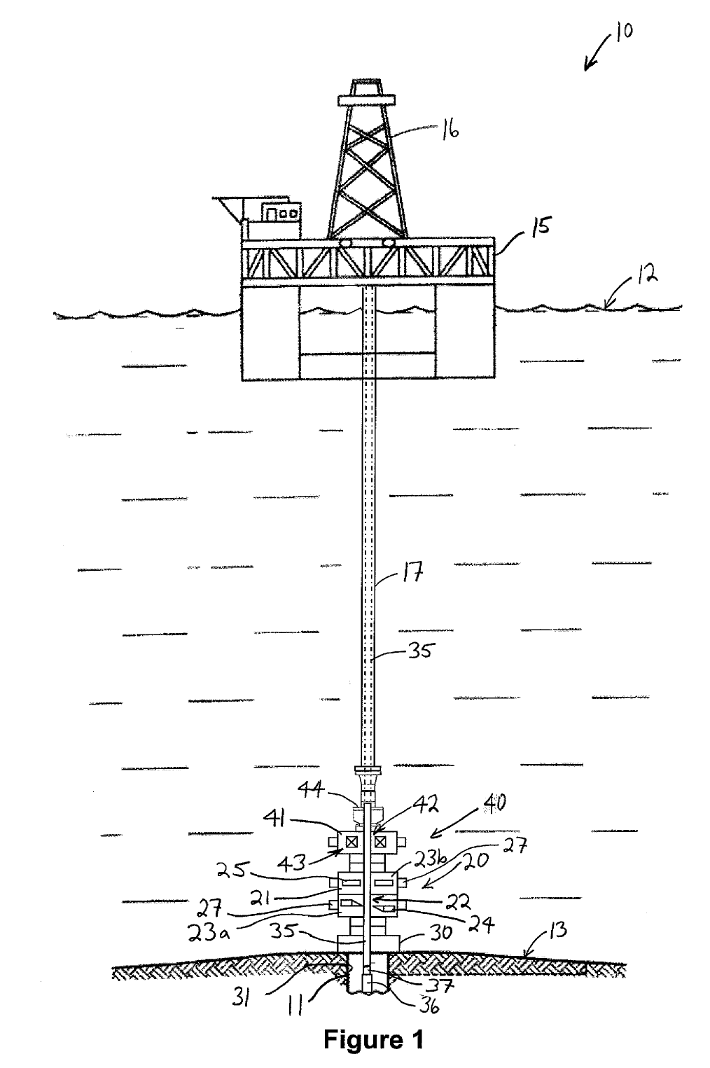

Referring now to FIG. 1, an offshore system 10 for drilling and/or producing a wellbore 11 is shown. System 10 includes an offshore platform 15 at the sea surface 12, a subsea blowout preventer (BOP) 20 secured to a wellhead 30 at the sea floor 13, and a lower marine riser package (LMRP) 40. Platform 15 includes a derrick 16 that supports a hoist (not shown). A tubular riser 17 extends from platform 15 to LMRP 40, which is coupled to the upper end of BOP 20. During drilling operations, riser 17 takes mud returns to the platform 15. Casing 31 extends from wellhead 30 into subterranean wellbore 11. Although system 10 is shown and depicted as being used in conjunction with an offshore wellsite, various components thereof (e.g., BOP 20) may be employed in land-based or offshore drilling, completion, and/or production operations.

Downhole operations are carried out by a tubular string 35 (e.g., drillstring, production tubing string, coiled tubing, etc.) that is supported by derrick 16 and extends from platform 15 through riser 17, LMRP 40, BOP 20, and into cased wellbore 11. A downhole tool 36 is connected to the lower end of tubular string 35 with a tool joint 37. In general, downhole tool 36 may comprise any suitable downhole tool for drilling, completing, evaluating and/or producing wellbore 11, such as drill bits, packers, testing equipment, perforating guns, and the like. During downhole operations, string 35, tool 36, and joint 37 move axially, radially, and rotationally thereof relative to riser 17, LMRP 40, BOP 20, and casing 31.

Referring still to FIG. 1, BOP 20 and LMRP 40 are configured to controllably seal wellbore 11. In particular, LMRP 40 functions to engage and seal around tubular string 35, thereby closing off the annulus between tubular string 35 and riser 17. LMRP 40 has a body 41 with an upper end coupled to the lower end of riser 17, a lower end coupled to BOP 20, and a throughbore 42 extending axially therethrough. LMRP 40 also includes an annular blowout preventer 43 comprising an annular elastomeric sealing element that is mechanically squeezed radially inward to seal on a tubular extending through bore 42 (e.g., string 35, casing, drillpipe, drill collar, etc.) or seal off bore 42. In this embodiment, the upper end of LMRP 40 comprises a riser flex joint 44 that allows riser 17 to deflect angularly relative to BOP 20 and LMRP 40 while hydrocarbon fluids flow from wellbore 11, BOP 20 and LMRP 40 into riser 17.

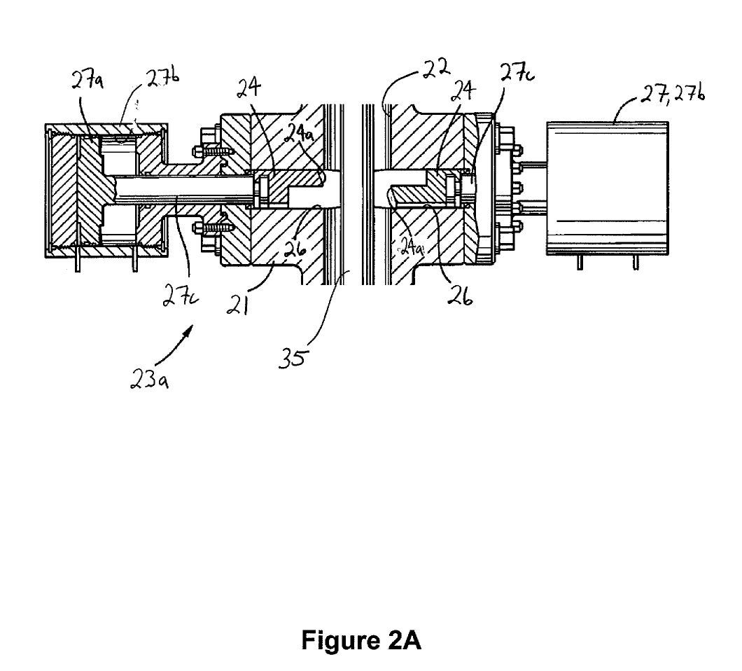

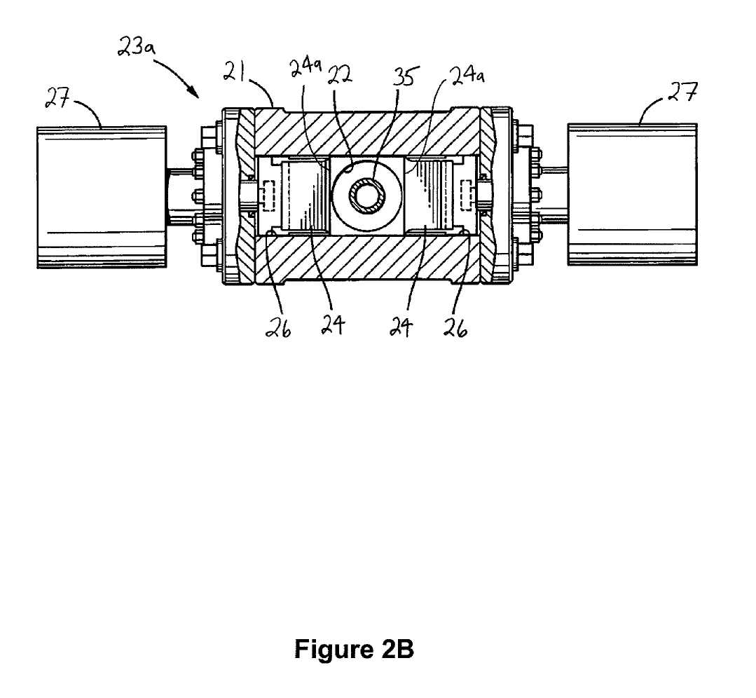

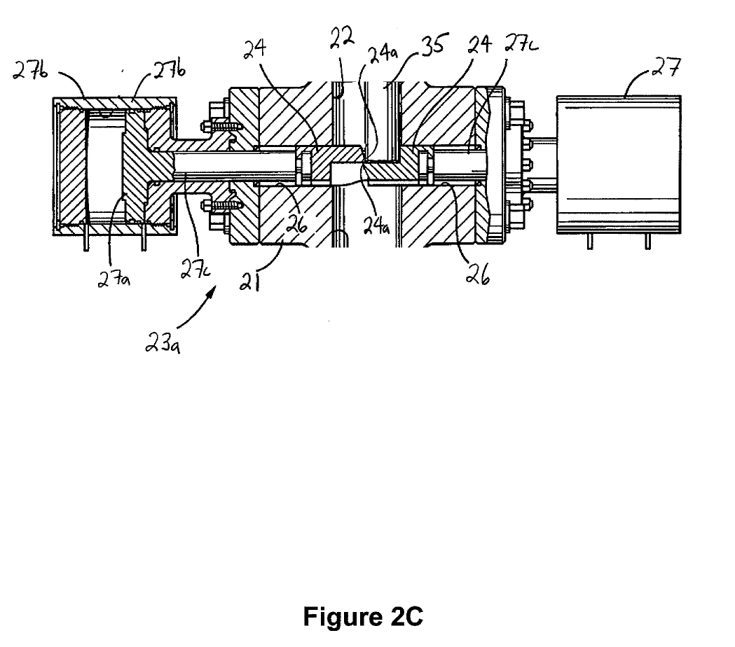

Referring now to FIGS. 1 and 2A-2C, BOP 20 includes a body 21 with an upper end coupled to LMRP 40, a lower end coupled to wellhead 30, and a main bore 22 extending axially therethrough. Main bore 22 is aligned with wellbore 11 and throughbore 42, thereby allowing fluid communication between wellbore, main bore 22, and throughbore 42. In addition, BOP 20 includes a plurality of axially stacked ram BOPs 23a, b. In this embodiment, ram BOP 23a includes a pair of opposed blind shear rams or blades 24 for severing tubular string 35 and sealing off wellbore 11 from riser 17, and ram BOP 23b includes opposed pipe rams 25 for engaging string 35 and sealing the annulus around tubular string 35.

Opposed rams 24, 25 are disposed in ram guideways 26 that intersect main bore 22 and support rams 24, 25 as they move into and out of main bore 22. Each set of rams 24, 25 is actuated and transitioned between an “open” or “retracted” position and a “closed” or “extended” position. In the open positions, rams 24, 25 are radially withdrawn from main bore 22 and do not interfere with tubular string 35 or other hardware that may extend through main bore 22. However, in the closed positions, rams 24, 25 are radially advanced into main bore 22 to close off and seal main bore 22 (e.g., rams 24) or the annulus around tubular string 35 (e.g., rams 25). Rams 24, 25 are transitioned between the open and closed positions by actuators 27. As best shown in FIGS. 2A-2C, in this embodiment, each actuator 27 moves a piston 27a within a cylinder 27b in order to move a drive rod 27c coupled to a corresponding ram 24, 25. Ram guideways 26 guide rams 24, 25 within the BOP 20 as the actuators 27 move rams 24, 25 between the open and closed positions.

Referring still to FIGS. 2A-2C, when shear rams 24 are transitioned to the closed position with associated actuators 27, shear rams 24 extend radially across bore 22 and sever any hardware extending therethrough (e.g., tubular string 35, tool joint 37, etc.). After the hardware is severed, the lower portion of the hardware may drop into wellbore 11 below BOP 20 or hang off a lower set of rams (not shown). With the hardware severed, shear rams 24 extending across bore 22 and/or another piece of equipment may then seal off wellbore 11 in order to prevent an oil leak and/or explosion.

In this embodiment, shear rams 24 are positioned to move radially past one another within bore 22 when actuated to the closed position. For example, as shown in FIGS. 2A and 2C, the left shear ram 24 passes above the right shear ram 24 as shear rams 24 are actuated to the closed position and move radially inward toward tubular string 35. In general, actuators 27 may actuate shear rams 24 in response to direct control from a controller (surface or subsea), an operator, or a condition in the wellbore 11 (as shown in FIG. 1) such as a pressure surge. In this embodiment, actuators 27 are hydraulically operated, however, in other embodiments, shear rams 24 may be actuated by other suitable means including, without limitation, pneumatic actuation, electric motors, or combinations thereof.

During downhole operations, tubular string 35 or tool joint 37 may be positioned within BOP bore 22 between shear rams 24. Typically, a tubular string (e.g., tubular string 35, drillpipe string, etc.) is easier to shear with shear rams (e.g., shear rams 24) than a tool joint (e.g., tool joint 37), especially if the tool joint includes hardbanding. However, as will be described in more detail below, embodiments of downhole tools (e.g., tool joints) described herein include a hardband that is both shearable and casing friendly. Moreover, as will be described in more detail below, embodiments of BOPs and BOP shear rams described herein offer the potential to enhance BOP shearing capabilities with regard to hardbanded tool joints.

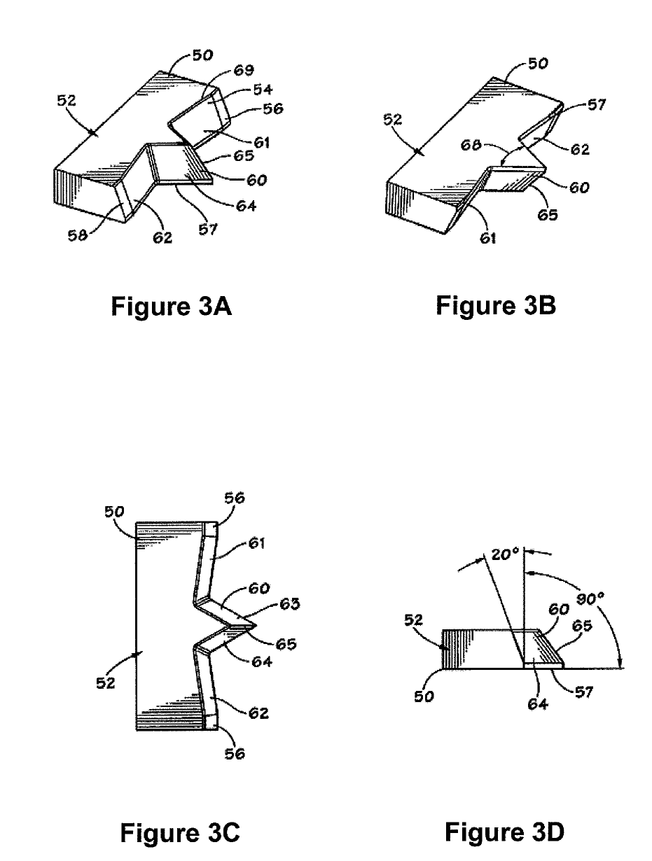

As shown in FIGS. 2A-2C, each shear ram 24 has a cutting edge 24a. In this embodiment, each cutting edge 24a is straight in top view and beveled in side view. However, in other embodiments, the shear rams may be non-linear and/or include one or more cutting tips or points that initially engage the hardware extending through the BOP to facilitate the formation of holes or punctures in the hardware, thereby easing the subsequent shearing of the hardware. Examples of alternative geometries for the cutting edges of the shear rams are disclosed in U.S. Pat. No. 7,367,396 and U.S. Patent Application Ser. No. 61/373,734, each of which is incorporated herein by reference in its entirety for all purposes. Examples of such alternative geometries for the shear rams are shown in FIGS. 3A-10D.

Referring now to FIGS. 3A-3D, an exemplary shear ram or blade 50 has a body 52 with a base 57 and a front face 54. The front face 54 has two inclined portions 61, 62 and a projection 60 that projects from the front face 54 between the two inclined portions 61, 62. Edges 56, 58 are at ends of the inclined portions 61, 62, respectively. The projection 60 has two inclined faces 63, 64 which meet at a central edge 65. An angle 68 between the faces 63, 64 (as may be true for the angle between any two projection faces according to embodiments described herein) may be any desired angle and, in certain aspects, ranges between 20 degrees to ninety degrees and, in certain particular aspects, is 20 degrees, 60 degrees, or 90 degrees.

In certain aspects (as is true for any blade according to embodiments described herein) the cutting surfaces are slopped from the vertical and in one particular aspect, as shown in FIG. 3D, the two inclined portions 61, 62 are at an angle of 20 degrees from the vertical. In other aspects the angle for any cutting surface of any blade according to the present invention ranges between 20 degrees and 60 degrees; and, in certain aspects, the angle is 20 degrees, 45 degrees, or 60 degrees.

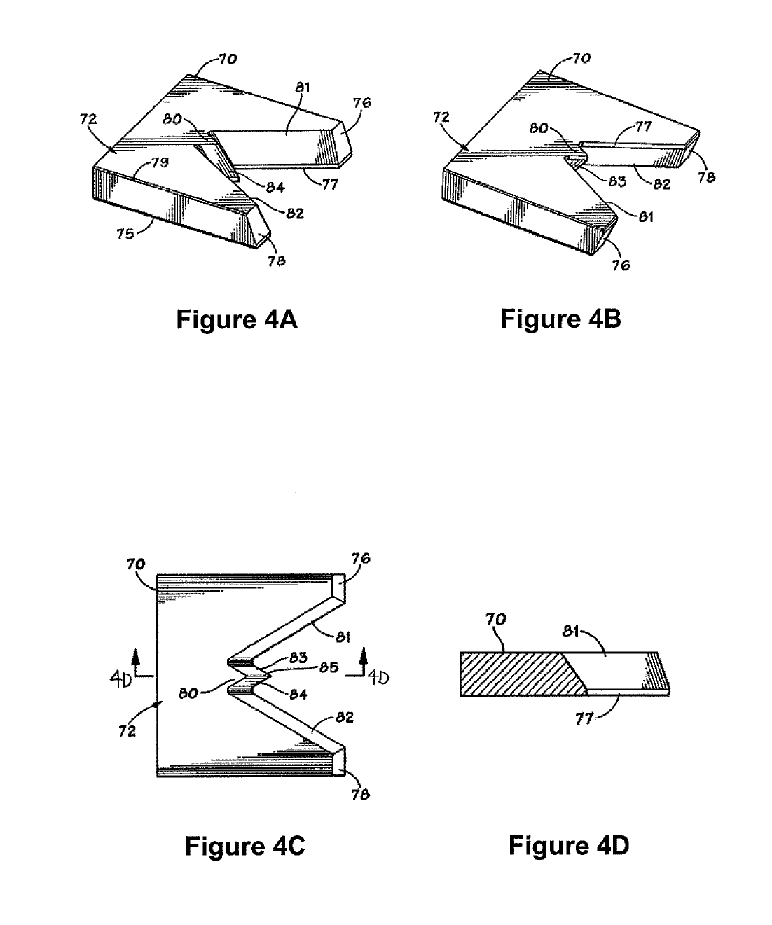

Referring now to FIGS. 4A-4D, another exemplary shear ram or blade 70 has a body 72 with a base 77, two opposed inclined faces 81, 82 and a projection 80 between the two inclined faces 81, 82. The projection 80 has two inclined faces 83, 84 which meet at a central edge 85. Inclined end portions 76, 78 are at ends of the faces 81, 82 respectively.

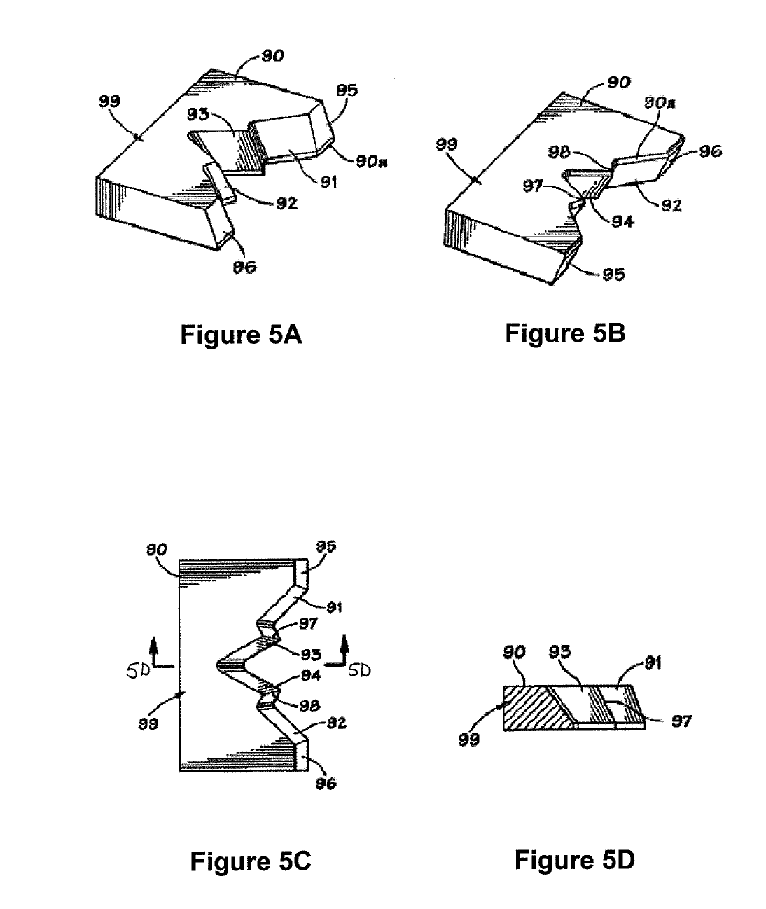

Referring now to FIGS. 5A-5D, another exemplary shear ram or blade 90 has a body 99; opposed inclined faces 91, 92; opposed inclined faces 93, 94; and inclined end portions 95, 96. Projections 97, 98 are formed between faces 91, 93 and 94, 92, respectively. The blade 90 has a base 90a.

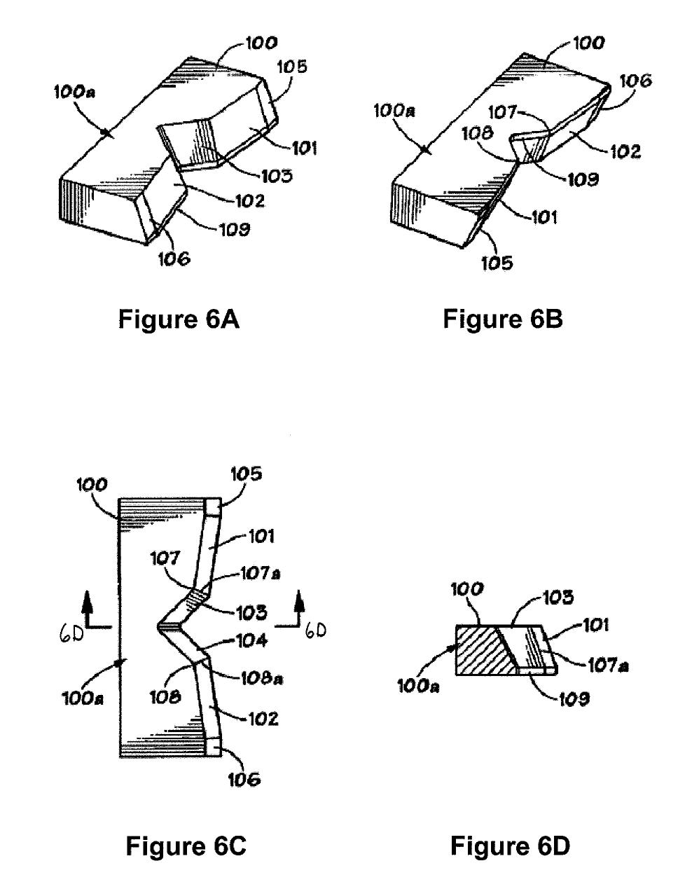

Referring now to FIGS. 6A-6D, another exemplary shear ram or blade 100 has a body 100a; opposed inclined faces 101, 102; opposed inclined faces 103, 104; and opposed inclined end portions 105, 106. Projections 107, 108 are formed between faces 101, 103 and 104, 102, respectively. The blade 100 has a base 109. Projection 107 has an edge 107a and projection 108 has an edge 108a.

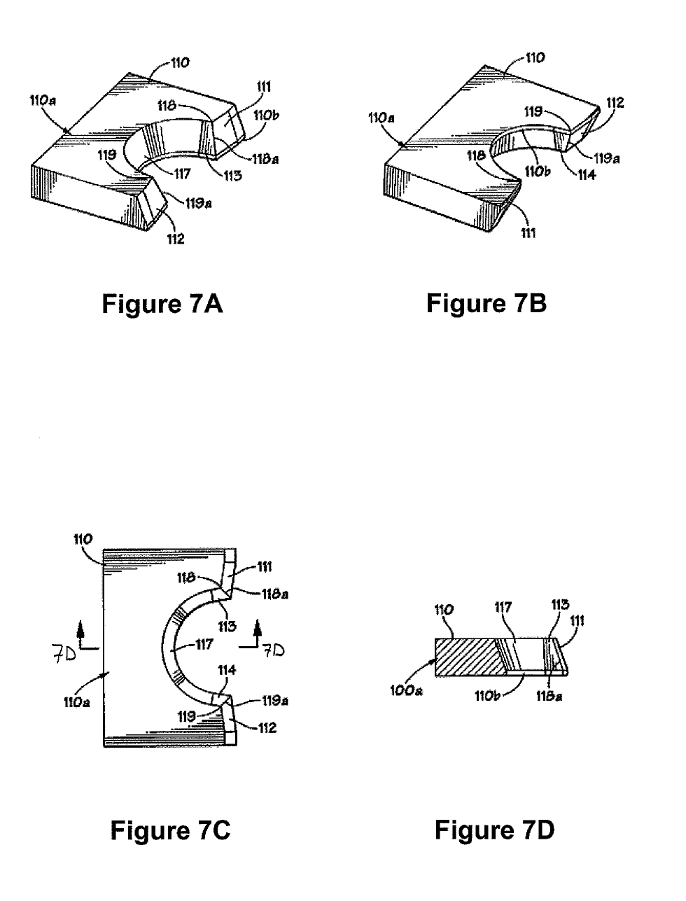

Referring now to FIGS. 7A-7D, another exemplary shear ram or blade 110 has a body 110a, two inclined faces 111, 112; two opposed inclined faces 113, 114; inclined end portions 115, 116; a central semicircular inclined face 117; and a base 110b. Projections 118, 119 are formed between faces 111, 113 and 114, 112, respectively. Projection 118 has an edge 118a and projection 119 has an edge 119a.

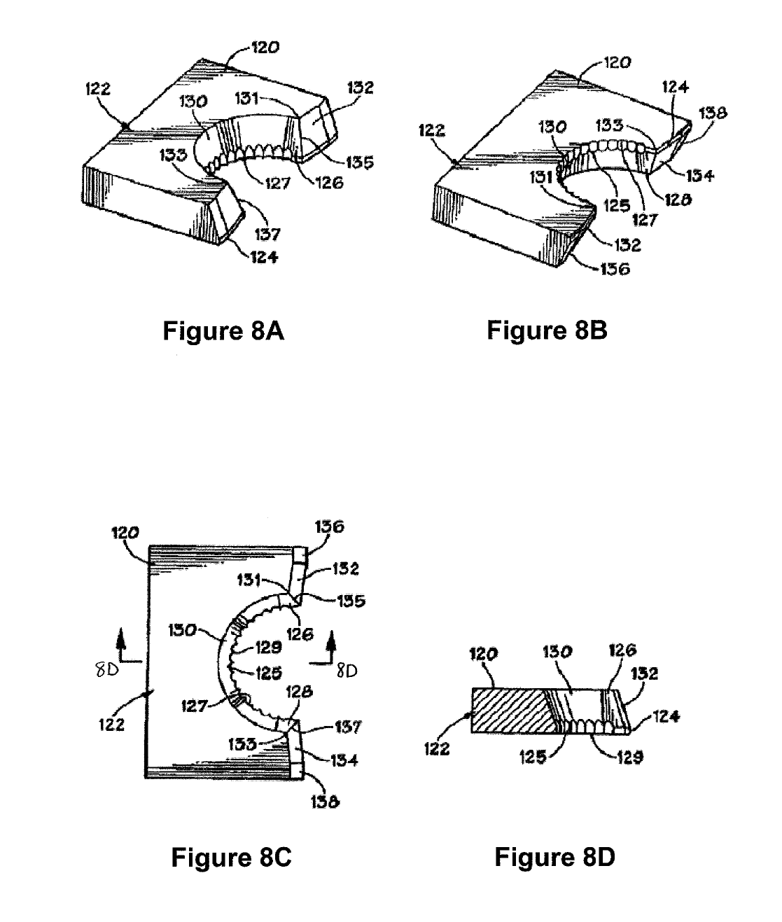

Referring now to FIGS. 8A-8D, another exemplary shear ram or blade 120 has a body 122; a base 124; opposed inclined faces 126, 128; inclined faces 132, 134; inclined end portions 136, 138; and a semicircular inclined face 120. A serrated cutting surface 125 extends around a lower edge 127 of the face 120 and extends partially onto the faces 126, 128. As shown the serrations of the surface 125 have pointed tips 129; but, optionally, these tips may be rounded off. The faces 126, 132 are at an angle to each other forming a projection 131 with an edge 135. The faces 128, 134 are at an angle to each other forming the projection 133 with an edge 137.

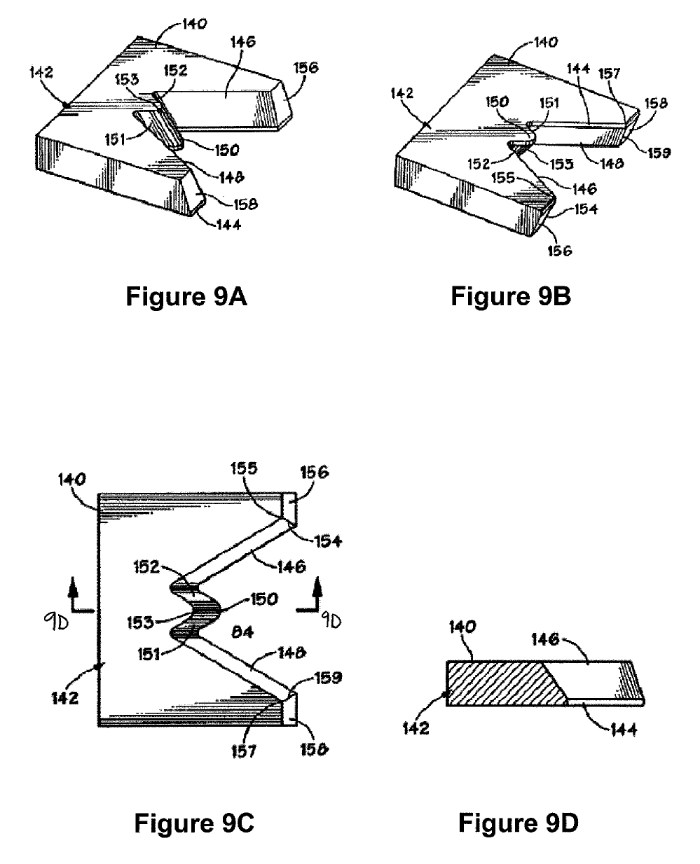

Referring now to FIGS. 9A-9D, another exemplary shear ram or blade 140 has a body 142; a base 144; opposed inclined faces 146, 148; a projection 150 between the faces 146, 148; and inclined end portions 156, 158. The projection 150 has inclined faces 151, 152 and a center face 153. A projection 155 is formed between the faces 156, 146 having an edge 154. A projection 157 is formed between the faces 148, 158 having an edge 159. Optionally, as shown, the projection 150 is rounded off.

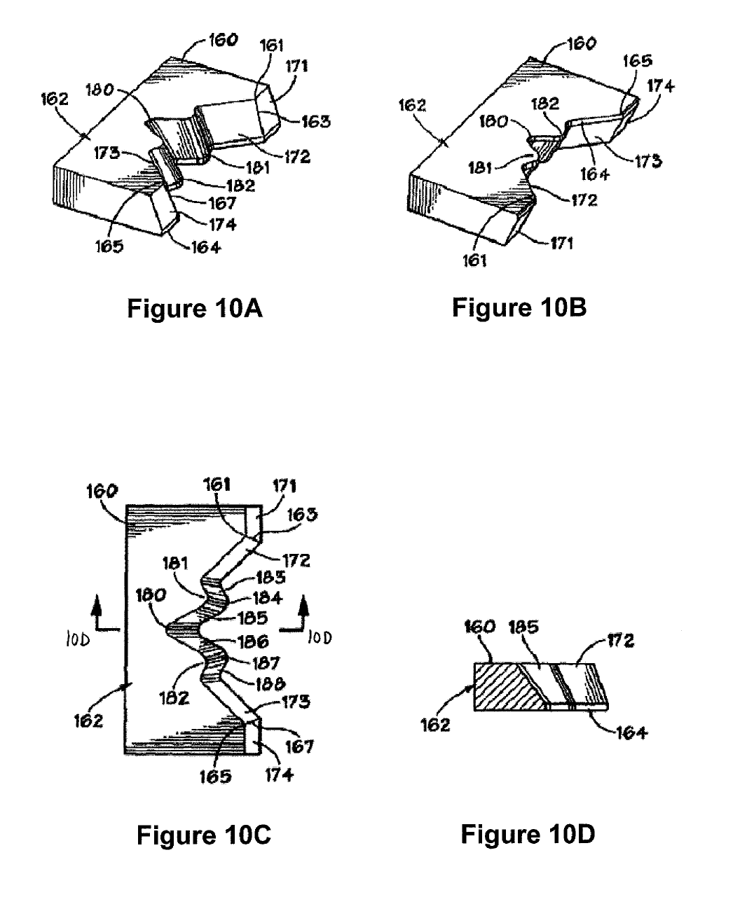

Referring now to FIGS. 10A-10D, another exemplary shear ram or blade 160 has a body 162; a base 164; opposed inclined faces 172, 173; inclined end portions 171, 174; projections 181, 182; and a recess 180 formed between the projections 181, 182. A projection 161 with an edge 163 is formed between the face 172 and the end portion 171. A projection 165 with an edge 167 is formed between the face 173 and the end portion 174. The projection 181 has inclined faces 183, 185 and an inclined center portion 184. The projection 182 has inclined faces 186, 188 and an inclined center portion 187. Optionally, as shown, the projections 181, 182 are rounded off.

Each shear ram (e.g., shear ram 24, 50, 70, 90, 100, etc.) is made from hardened tool steel. In addition, each shear ram, and in particular the cutting edge of each shear ram, may be (a) coated or overlaid with a hardfacing material to enhance the hardness of the cutting edge, or (b) uncoated. Any such hardfacing coating or overlay preferably has a hardness greater than 65 HRC. For example, the shear rams may include a weld overlay hardfacing material such as Nanosteel® Super Hard Steel® (SHS) 9700 available from the Nanosteel Company, Inc. of Providence R.I. Alternatively, the cutting edge may be nitrided with a thin diamond overlay or a plasma transfer arc application of a hard coating.

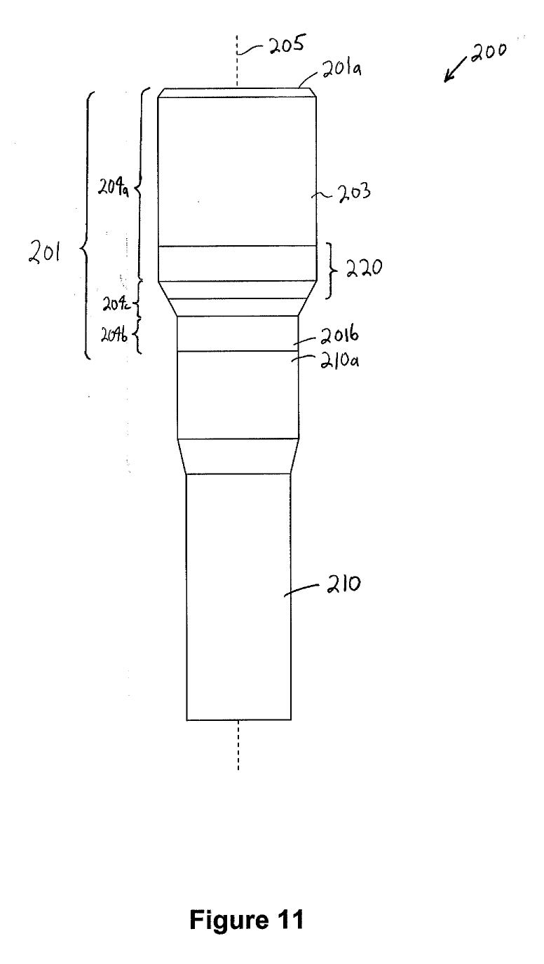

Referring now to FIG. 11, an embodiment of a downhole tool or device 200 including an annular hardband 220 is shown. In this embodiment, downhole device 200 is a tool joint 201 connected to a pipe section or tubular segment 210. Specifically, tool joint 201 is welded end-to-end to an upper end 210a of pipe section 210 and is configured to receive a mating tool joint shown). In general, a tool joint (e.g., tool joint 201) may be employed to (a) couple individual tubular segments together end-to-end to form an elongate tubular string, or (b) to couple downhole tools to a tubular string. Such downhole tools may include any tool used for drilling, completing, evaluating and/or producing a borehole (e.g., wellbore 11) including, without limitation, drill bits, packers, testing equipment, perforating guns, etc. For example, tubular segment 210 may be the lower pipe joint in string 35 previously described, and joint 201 may be joint 37 previously described. Joint 201 and hardband 220 are casing friendly and shearable, and thus, offer the potential to reduce abrasive wear to the riser (e.g., riser 17) and/or casing (e.g., casing 31) through which they extend and move relative to, while simultaneously being shearable by shear rams (e.g., rams 24, 50, 70, 90, 100, etc.) of a ram BOP (e.g., ram BOP 23a). Such shear rams may be coated or uncoated as previously described. In other words, joint 201 and hardband 220 may be cut with coated or overlaid shear rams having enhanced hardness as well as with conventional uncoated shear rams.

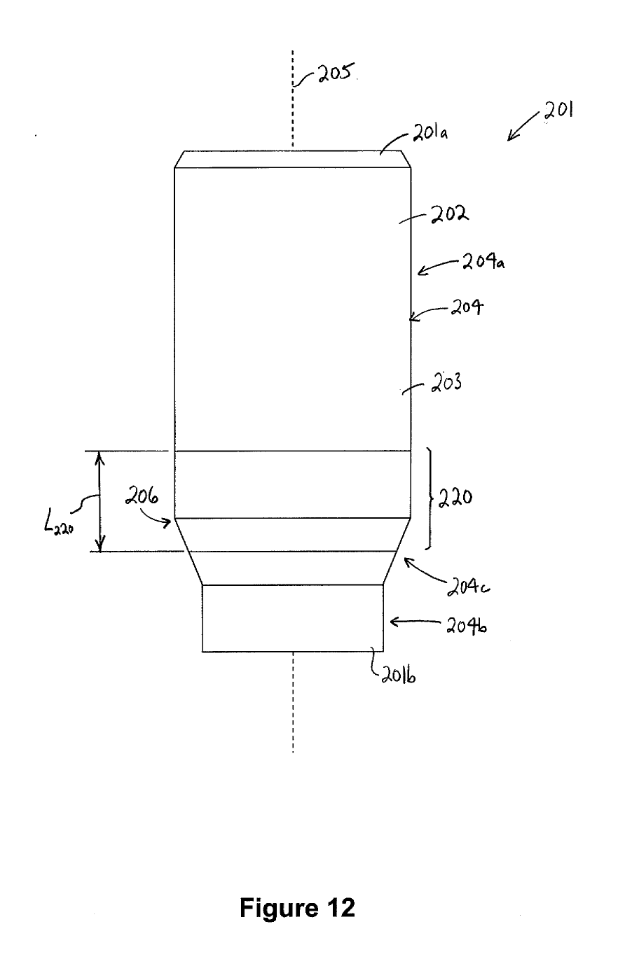

Referring now to FIGS. 11 and 12, tool joint 201 has a central axis 205 coaxially aligned with pipe section 210, a first or upper end 201a adapted to threadably engage an axially adjacent tool joint that is coupled to the lower end of another pipe section, and a second or lower end 201b connected to upper end 210a of pipe section 210. In this embodiment, second end 201b is welded to upper end 210a of pipe section 210, and first end 201a comprises a box end 202 configured to threadably receive a mating pin end of another tool joint disposed at the lower end of an adjacent pipe section. Although first end 201a comprises box end 202 in this embodiment, in other embodiments, the first end distal the pipe section may comprise a pin end. Thus, in general, the end of a tool joint that is distal its associated pipe segment may comprise a pin end or a box end adapted to matingly engage a mating box end or pin end, respectively, provided on an adjacent pipe section or downhole tool.

Tool joint 201 includes a body 203 and annular band of hardfacing 220, which may also be referred to as hardband 220, disposed about and mounted to body 203. In this embodiment, hardband 220 extends around the entire circumference of body 203 and has an axial length L₂₂₀ that is less than the axial length of body 203. In addition, body 203 has a radially outer surface 204 comprising a cylindrical section 204a extending axially from first end 201a, a cylindrical section 204b extending axially from second end 201b, and a frustoconical section 204c extending axially between sections 204a, b. The radius of section 204a is greater than the radius of section 204b, and the radius of section 204c transitions from the radius of section 204a to the radius of section 204b. Consequently, an angular intersection 206 is formed at the intersection of sections 204a and 204c. Hardband 220 extends axially across angular intersection 206.

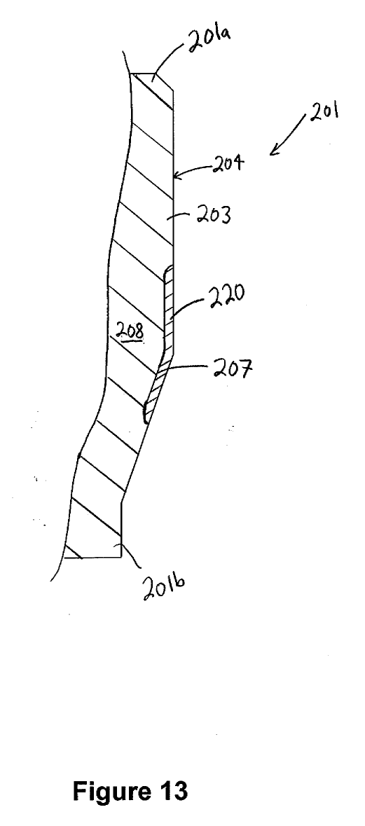

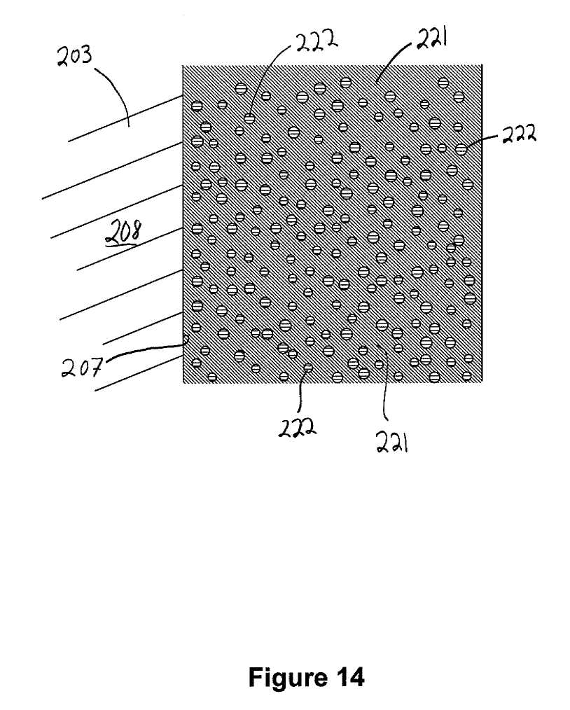

Referring now to FIGS. 13 and 14, outer surface 204 includes an annular recess or groove 207 extending axially from section 204a into section 204b. Thus, groove 207 extends axially across upset 206. Groove 207 may be molded or cast as part of body 203 or machined into body 203. Hardband 220 is disposed about body 203 within groove 207. In other embodiments, no annular recess or groove is provided and the hardband (e.g., hardband 220) is directly applied to the outer surface of the tool joint body (e.g., body 203).

Referring still to FIGS. 13 and 14, body 203 is made of a metal or metal alloy base material 208. In general, metals and metal alloys with a hardness less than 46 HRC are shearable by conventional uncoated straight blade shear rams (e.g., shear rams 24), however, shearability with conventional uncoated straight blade shear rams becomes questionable for metals and metal alloys with a hardness between 46 and 50 HRC, and metals and metal alloys with a hardness above 50 HRC are generally not shearable with conventional uncoated straight blade shear rams. Thus, to ensure base material 208 is shearable, it preferably comprises a metal or metal alloy having a hardness less than 50 HRC, and more preferably less than 46 HRC. In this embodiment, base material 208 comprises a steel, such as a low alloy carbon steel, having a hardness between 25 and 40 HRC.

Referring still to FIGS. 13 and 14, hardband 220 comprises a base material 221 and a plurality of discrete pellets 222 dispersed throughout base material 221. In embodiments described herein, base material 221 is a metal or metal alloy that is applied to tool joint 201 in a molten, liquid form, such as via welding, and pellets 222 are solid particles fed into and dispersed throughout material 221 while material 221 is in the molten, liquid state. It should be appreciated that during application of hardband 220 to tool joint 210, thermal energy will be transferred from the molten base material 221 to tool body 203. In particular, the portions of tool body base material 208 defining and adjacent groove 207 may drastically increase in temperature, and may even soften or transition into a liquid form. After the solid pellets 222 are dropped into the molten, liquid base material 221, it is allowed to cool and harden, thereby locking the position of pellets 222 therewithin. To reduce the likelihood of cracks in hardband base material 221 as it cools along with the portions of body base material 208 proximal groove 207, hardband base material 221 preferably comprises a metal or metal alloy having a coefficient of thermal expansion that is the same or similar to the coefficient of thermal expansion of tool joint body base material 208. In particular, the coefficient of thermal expansion of hardband base material 221 is preferably within 15%, and more preferably within 10%, of the coefficient of thermal expansion of tool body base material 208. Further, to ensure shearability of tool joint 201, hardband base material 221 preferably comprises a metal or metal alloy with a hardness less than 50 HRC, and more preferably less than 46 HRC. In this embodiment, base material 221 is made of the same metal alloy as base material 208. Thus, in this embodiment, base material 221 comprises a steel matrix such as a low alloy carbon steel.

As best shown in FIG. 14, pellets 222 comprise discrete particles of solid material dispersed throughout base material 221. To provide enhanced protection to tool joint 10, while simultaneously remaining casing friendly, pellets 222 preferably comprise a material having a hardness greater than the hardness of base materials 208, 221, but less than the hardness of conventional tungsten carbide (WC). As previously described, in this embodiment, base material 208 comprises a steel, such as a low alloy carbon steel, having a hardness between 25 and 40 HRC. Further, tungsten carbide has a hardness of about 2300 HV (Vickers). Thus, pellets 222 preferably have a hardness greater than 35 HRC and less than 2300 HV (Vickers). Examples of suitable materials for pellets 222 include, without limitation, ceramics such as zirconium oxide and carbide alloys other than tungsten carbide such as niobium carbide, chromium carbide, and nickel-chromium carbide. In general, one or more pellets 222 may comprise the same or different materials. Although other geometries may be employed, each pellet 42 preferably has a spherical geometry with a mesh size between 10 and 25 (i.e., diameter between about 2000 and 707 micron), and more preferably between 12 and 24 (i.e., diameter between about 1680 and 735 micron).

Pellets 222 are preferably uniformly and evenly distributed throughout base material 221. In other words, the number of pellets 222 per unit volume of base material 221 is preferably substantially uniform throughout hardband 220. The distribution of pellets 222 within base material 221 depend, at least in part, on the density of pellets 222 relative to the density of molten base material 221 during application of hardband 220. For example, if pellets 222 have a density greater than the density of molten base material 221, pellets 222 will tend to sink relative to the surrounding base material 221 under the force of gravity. On the other hand, if pellets 222 have a density less than the density of base material 221, pellets 222 will tend to rise relative to the surrounding base material 221. Thus, to ensure a substantially uniform distribution of pellets 222 within base material 221, pellets 222 preferably have a density substantially the same or similar (e.g., slightly higher or slightly lower) to that of molten base material 221. As previously described, in this embodiment, base material 221 comprises a steel matrix, which has a density of about 6.9 to 8.5 g/cm³ in liquid form. Thus, in this embodiment, pellets 222 preferably have a density between 6.0 and 8.5 g/cm³, and more preferably between 7.5 and 8.0 g/cm³ to enable substantially even distribution of pellets 222 throughout base material 221.

As previously described, base material 221 is applied to groove 207 in a liquid, molten form, followed by dropping pellets 222 into the liquid base material 221, and then gradually cooling the mixture to allow base material 221 harden. Pellets 222 preferably comprise a material with a melting point that is higher than the molten base material 221 such that pellets 222 remain discrete particles within base material 221 and do not melt into base material 221 during application to body 203. For instance, exemplary materials for pellets 222 previously described (i.e., ceramics such as zirconium oxide and carbide alloys other than tungsten carbide such as niobium carbide, chromium carbide, and nickel-chromium carbide) each have a melting point greater than the melting point of a steel matrix base material 221. Further, the solid pellets 222 may need to be “wet” into the liquid molten base material 221. Relatively small alloying additions to base material 221 or pellets 222 may enhance the ability to “wet” pellets 222 into the molten base material 221.

Although downhole device 200 is shown and described as a downhole tubular including a pipe section 210 and a tubing joint 201, and hardbanding 220 is shown and described as being applied to tool joint 201, it should be appreciated that embodiments of casing friendly, shearable hardbanding described herein (e.g., hardband 220) may also be employed on other types of downhole devices and equipment such as tubulars, tools, couplings, collars, wear pads of heavy weight drill pipe, etc.

As previously described, embodiments of hardbanding described herein include discrete particles or pellets distributed throughout a metal or metal alloy base material (e.g., a steel matrix). The hardband base material preferably comprises a material that is shearable by BOP rams and has material properties similar to that of the material that forms the underlying tool, joint, or tubular to which the hardband is applied. Further, the pellets are preferably not as abrasive or hard as tungsten carbide so as to offer the potential for reduced casing wear. Accordingly, embodiments described herein offer the potential for an improved hardband combining casing friendly performance characteristics with the ability to be sheared during emergency operations with conventional shear rams such as those shown in FIGS. 2A-2C or advanced BOP shear rams such as those shown in FIGS. 3A to 10D. The recent increase in focus on the safety of oilfield drilling operations has highlighted the importance of BOPs and their ability to shear through various components along the drillstring or tubular string. The ability to shear through the tool joints, which are typically larger and thicker than the pipe string or tubular string from which the tool joint is connected, offers the potential to improve overall safety during well drilling operations. Furthermore, severe casing wear cannot be tolerated because this can jeopardize well integrity and safety of operations.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the invention. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simply subsequent reference to such steps.

What is claimed is:

1. A tool joint, comprising:
a body having a central axis, a first end, and a second end opposite the first end, wherein the body is made of a first material having a first hardness;
an annular hardband disposed about the body, wherein the hardband is made of a second material;
wherein the second material comprises a base material and a plurality of discrete pellets dispersed throughout the base material, wherein the base material has a second hardness and the pellets have a third hardness;
wherein the second hardness is substantially the same as the first hardness;
wherein the third hardness is greater than the second hardness and less than the hardness of tungsten carbide.

2. The tool joint of claim 1, wherein the pellets are spherical.

3. The tool joint of claim 2, wherein each pellet has a diameter between 707 micron and 2000 micron.

4. The tool joint of claim 1, wherein the first material has a coefficient of thermal expansion, and wherein the base material of the hardband has a coefficient of thermal expansion that is within 10% of the coefficient of thermal expansion of the first material.

5. The tool joint of claim 4, wherein the first material is the same as the base material, and wherein the first material and the base material each have a hardness less than 46 HRC.

6. The tool joint of claim 5, wherein the first material and the base material are both low alloy carbon steels having a hardness between 25 HRC and 40 HRC.

7. The tool joint of claim 5, wherein each pellet has a hardness between 35 HRC and 2300 HV.

8. The tool joint of claim 7, wherein the pellets are made of a material selected from a ceramic, niobium carbide, chromium carbide, and nickel-chromium carbide.

9. The tool joint of claim 1, wherein the base material of the hardband has a density in a liquid state, wherein the pellets have a density that is within 10% of the density of the base material in the liquid state.

10. The tool joint of claim 1, wherein the body has an outer surface including an annular recess, and wherein the hardband is disposed in the recess.

11. A system, comprising:
a blowout preventer including a body, a throughbore in fluid communication with a wellbore, a shear ram, and an actuator configured to move the shear ram from a first positioned retracted from the throughbore and a second position extending across the throughbore;
a tool joint disposed in the throughbore of the blowout preventer radially adjacent the shear ram;
wherein the tool joint comprises a body and an annular hardband disposed about the body;
wherein the body is made from a first material and the hardband is made from a second material;
wherein the second material includes a base material and a plurality of discrete pellets dispersed throughout the base material;
wherein the base material has substantially the same hardness as the first material, and the pellets have a hardness greater than 35 HRC and less than 2300 HV.

12. The system of claim 11, wherein the pellets are spherical, each pellet having a diameter between 707 micron and 2000 micron.

13. The system of claim 11, wherein the first material has a coefficient of thermal expansion, and wherein the base material has a coefficient of thermal expansion that is within 10% of the coefficient of thermal expansion of the first material.

14. The system of claim 13, wherein the first material and the base material comprise the same metal or metal alloy.

15. The system of claim 11, wherein the first material and the base material are both low alloy carbon steels having a hardness between 25 HRC and 40 HRC.

16. The system of claim 15, wherein each pellet is made of a material selected from a ceramic, niobium carbide, chromium carbide, and nickel-chromium carbide.

17. The system of claim 11, wherein the pellets have a density that is within 10% of the density of the base material in a liquid state.

18. The system of claim 17, wherein the density of the pellets is between 6.0 and 8.5 g/cm³.

19. A method for forming a hardband on a downhole tool, the downhole tool being made of a first material, the method comprising:
(a) applying a molten base material onto the downhole tool, wherein the base material has a coefficient of thermal expansion that is within 10% of the coefficient of thermal expansion of the first material;
(b) dispersing a plurality of solid pellets throughout the molten base material, wherein the pellets have a hardness that is greater than a hardness of the base material and less than 2300 HV; and
(c) allowing the molten base material to cool and transition into a solid.

20. The method of claim 19, further comprising:
forming an annular recess on an outer surface of the downhole tool;
wherein (a) comprises disposing the molten base material in the recess.

21. The method of claim 19, wherein the pellets have a density that is within 10% of the density of the molten base material.

22. The method of claim 21, wherein the density of the pellets is between 6.0 and 8.5 g/cm³.

23. The method of claim 19, wherein the first material is a low alloy carbon steel and the base material is a low alloy carbon steel; and
wherein each pellet is made of a material selected from a ceramic, niobium carbide, chromium carbide, and nickel-chromium carbide.
